(19) United States
(12) Patent Application Publication
(10) Pub. No.: US 2003/0223913 A1
(43) Pub. Date: Dec. 4, 2003

(54) Microfluidic separation devices and methods

(75) Inventors: Christoph D. Karp, Pasadena, CA (US); Ronald C. Gamble, Altadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/219,597

(22) Filed: Aug. 14, 2002

Related U.S. Application Data
(63) Continuation-in-part of application No. 10/161,415, filed on Jun. 3, 2002.

(51) Int. Cl. G01N 1/00

(52) U.S. Cl. 422/101; 422/100; 436/177

(57) ABSTRACT

A pressure-driven microfluidic device for separating chemical or biological species from a sample provides on-column sample injection from a sample loading segment, with mobile phase solvent supplied to both the separation column and the sample loading segment to promote high-quality separation. Multiple separation channels each having an associated sample loading segment may be provided in a single device, with a first mobile phase solvent being supplied to an upstream portion of each separation channel via a first channel network and a second mobile phase solvent being supplied to each sample loading segment via a second channel network. Methods for operating pressure-driven microfluidic separation devices include the steps of supplying a sample to a sample loading segment and flowing mobile phase solvent an associated separation channel upstream of the sample loading region.

### STATEMENT OF RELATED APPLICATION(S)

This application claims benefit of U.S. patent application Ser. No. 10/161,415 filed Jun. 2, 2002 and currently pending.

### FIELD OF THE INVENTION

The present invention relates to the design and fabrication of microfluidic devices and systems employing the same.

### BACKGROUND OF THE INVENTION

Chemical and biological separations are routinely performed in various industrial and academic settings to determine the presence and/or quantity of individual species in complex sample mixtures. There exist various techniques for performing such separations.

One separation technique, chromatography, encompasses a number of methods that are used for separating closely related components of mixtures. In fact, chromatography has many applications including separation, identification, purification, and quantification of compounds within various mixtures. Chromatography is a physical method of separation involving a sample (or sample extract) being dissolved in a mobile phase (which may be a gas, a liquid, or a supercritical fluid). While carrying the sample, the mobile phase is then forced (e.g., by gravity, by applying pressure, or by applying an electric field) through a separation ‘column’ containing an immobile, immiscible stationary phase. In column chromatography, the stationary phase refers to a coating on a solid support that is typically contained within a tube or other boundary. The mobile phase and stationary phase are chosen such that components of the sample have differing solubilities in each phase. A component that is quite soluble in the stationary phase will take longer to travel through it than a component that is not very soluble in the stationary phase but very soluble in the mobile phase. As a result of these differences in mobilities, sample components become separated from one another as they travel through the stationary phase.

One category of conventional chromatography systems includes pressure-driven systems. These systems are operated by supplying a pressurized mobile phase (typically one or more liquid solvents pressurized with a pump) to a separation column. Standard liquid chromatography columns have dimensions of several (e.g., 10, 15, 25) centimeters in length and between 3-5 millimeters in diameter, with capillary columns typically having internal diameters between 3-200 microns. Columns are typically packed with very small diameter (e.g., 5 or 10 micron) particles. Various types of stationary phase material are commercially available. Some of the more common examples include Liquid-Liquid, Liquid-Solid (Adsorption), Size Exclusion, Normal Phase, Reverse Phase, Ion Exchange, and Affinity.

It is important to minimize any voids in a packed column, since voids or other irregularities in a separation system can destroy an otherwise good separation. As a result, most conventional separation columns include specially designed end fittings (typically having compressible ferrule regions) designed to hold packed stationary phase material in place and prevent irregular flow-through regions.

As illustrated in FIG. 1, a separation column for use in a conventional pressure-driven chromatography system is typically fabricated by packing particulate material 14 into a tubular column body 12. A conventional column body 12 has a high precision internal bore 13 and is manufactured typically with stainless steel, although materials such as glass, fused silica, and/or PEEK are also occasionally used. Various methods for packing a column body may be employed. In one example, a simple packing method involves dry-packing an empty tube by shaking particles downward with the aid of vibration from a sonicator bath or an engraving tool. A cut-back pipette tip may be used as a particulate reservoir at the top (second end), and the tube to be packed is plugged with parafilm or a tube cap at the bottom (first end). Following dry packing, the plug is removed and the tube 10 is then secured at the first end with a ferrule 16A, a fine porous stainless steel fritted filter disc (or “frit”) 18, a male end fitting 20A, and a female nut 22A that engages the end fitting 20A. Corresponding connectors (namely, a ferrule 16B, a male end fitting 20B, and a female nut 22B) except for the frit 18 are engaged to the second end to secure the dry-packed tube 12. The contents 14 of the tube 12 may be further compressed by flowing pressurized solvent through the packing material 14 from the second end toward the first (frit-containing) end. When compacting of the particle bed has ceased and the fluid pressure has stabilized, there typically remains some portion of the tube 13 that does not contain densely packed particulate material. To eliminate the presence of a void in the column 10, the tube 13 is typically cut down to the bed surface (or a shorter desired length) to ensure that the resulting length of the entire tube 12 contains packed particulate 14, and the unpacked tube section is discarded. Thereafter, the column 10 is reassembled (i.e., with the ferrule 16B, male end fitting 20B, and female nut 22B affixed to the second end) before use.

A conventional pressure-driven liquid chromatography system utilizing a column 10 is illustrated in FIG. 2. The system 30 includes a solvent reservoir 32, a high pressure pump 34, a pulse damper 36, a sample injection valve 38, and a sample source 40 all located upstream of the column 10, and further includes a detector 42 and a waste reservoir 44 located downstream of the column 10. The high pressure pump 34 pumps mobile phase solvent from the reservoir 32. A pulse damper 36 serves to reduce pressure pulses generated by the pump 34. The sample injection valve 38 is typically a rotary valve having an internal sample loop for injecting a predetermined volume of sample from the sample source 40 into the solvent stream. Downstream of the sample injection valve 38, the column 10 contains stationary phase material that aids in separating species of the sample. Downstream of the column 10 is a detector 42 for detecting the separated species, and a waste reservoir 44 for ultimately collecting the mobile phase and sample products. A back pressure regulator (not shown) may be disposed between the column 10 and the detector 42.

The system 30 generally permits one sample to be separated at a time in the column 10. Due to its cost, a column 10 is often re-used for several separations (e.g., typically about 100 times). Following one separation, the column 10 may be flushed with a pressurized solvent stream in an attempt to remove any sample components still contained in the stationary phase material 14. However, this time-consuming flushing or cleaning step rarely yields a completely clean column 10. This means that, after the first separation performed on a particular column, every subsequent separation may potentially include false results due to contaminants left behind on the column from a previous run. Eventually, columns become fouled to the point that they are no longer useful, at which point they are generally discarded.

From the foregoing description, it is clear that conventional pressure-driven separation columns include numerous components and require numerous manufacturing steps. It would be desirable to reduce the number of parts required to fabricate separation columns, and to simplify their manufacture. It would also be desirable to reduce the cost of a separation column to permit the column to be disposed after a single use, thus eliminating potentially false results and time-consuming cleaning steps. It would be further desirable to provide high-throughput separation systems capable of separating multiple samples using a minimum number of expensive system components (e.g., pumps, pulse dampers, detectors, etc.). Additionally, in an improved separation device, it would be desirable to provide separation media capable of promoting high-quality and repeatable separation results.

Another separation technique utilizes an electric field applied across a column. These systems utilize a separation technique called electrophoresis, which is based on the mobility of ions in an electric field. Upon application of an electric field across a column containing an electrophoretic medium, components of the sample migrate at different rates toward the oppositely charged ends of the column based on their relative electrophoretic mobilities in the medium. Electrochromatography is a combination of chromatography and electrophoresis, in which the mobile phase is transported through the separation system by electroosmotic flow.

Separation systems relying on electric fields are complicated and require integral electrical contacts. Additionally, these systems only function with charged fluids or fluids containing electrolytes. Finally, these systems require voltages that are sufficiently high to cause electrolysis of water, thus forming bubbles that complicate the collection of samples without destroying them. In light of these limitations, there exists a need for devices and systems capable of providing separation utility without utilizing electrical currents.

### SUMMARY OF THE INVENTION

In a first separate aspect of the invention, a pressure-driven microfluidic separation device includes a microfluidic separation channel having an upstream portion and a downstream portion, both portions containing stationary phase material. A sample loading segment having a sample inlet port is in fluid communication with the separation channel at a sample loading junction. A first mobile phase solvent inlet is in fluid communication with the upstream portion upstream of the sample loading junction. A second mobile phase solvent inlet is in fluid communication with the sample loading segment upstream of the sample inlet port.

In a second separate aspect of the invention, a pressure-driven microfluidic separation device includes multiple microfluidic separation channels. Each separation channel has an associated sample loading junction, which demarcates a transition between an upstream portion and a downstream portion of the associated microfluidic separation channel. Multiple sample loading segments are provided, with each sample loading segment being in fluid communication with a separation channel at the associated sample loading junction. Each sample loading segment has a sample inlet port adapted to receive a liquid sample. A first mobile phase solvent inlet port is in fluid communication with each upstream portion via a first channel network. A second mobile phase solvent inlet port is in fluid communication with each sample loading segment via a second channel network.

In another separate aspect of the invention, a method for operating a pressure-driven microfluidic separation device includes several steps. A first step includes providing a microfluidic separation channel containing a stationary phase material, the separation channel having a sample loading region positioned between an upstream end and a downstream end of the channel. A second step includes providing a sample loading segment in fluid communication with the separation channel at a sample loading region. A third step includes introducing a sample into the sample loading segment. A fourth step includes supplying a first flow of mobile phase solvent to the separation channel upstream of the sample loading region.

In another separate aspect of the invention, any of the foregoing aspects may be combined for additional advantage. These and other aspects and advantages of the invention will be apparent to the skilled artisan upon review of the following detailed description, drawings, and claims.

### BRIEF DESCRIPTION OF THE DRAWINGS

FIG. 1 is a cross-sectional view of a conventional packed chromatography column.

FIG. 2 is a schematic showing various components of a conventional liquid chromatography system employing the packed chromatography column of FIG. 1.

FIG. 3A is top view of a portion of a first microfluidic separation device having a separation channel and a sample loading segment. FIG. 3A is a top view of a second microfluidic separation device having a separation channel and a sample loading bypass segment.

FIG. 4 is a schematic showing various components of a microfluidic chromatography system according to the present invention.

FIG. 5A is an exploded perspective view of a pressure-driven microfluidic separation device having eight separation channels, each separation channel having an associated sample input segment and a non-bypass sample loading segment. FIG. 5B is a top view of the assembled device of FIG. 5A.

FIG. 6A is an exploded perspective view of a pressure-driven microfluidic separation device having eight separation channels, each separation channel having an associated bypass sample input segment. FIG. 6B is a top view of the assembled device of FIG. 6A.

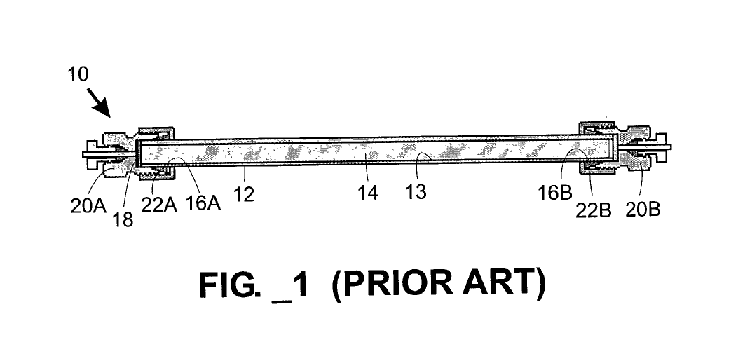

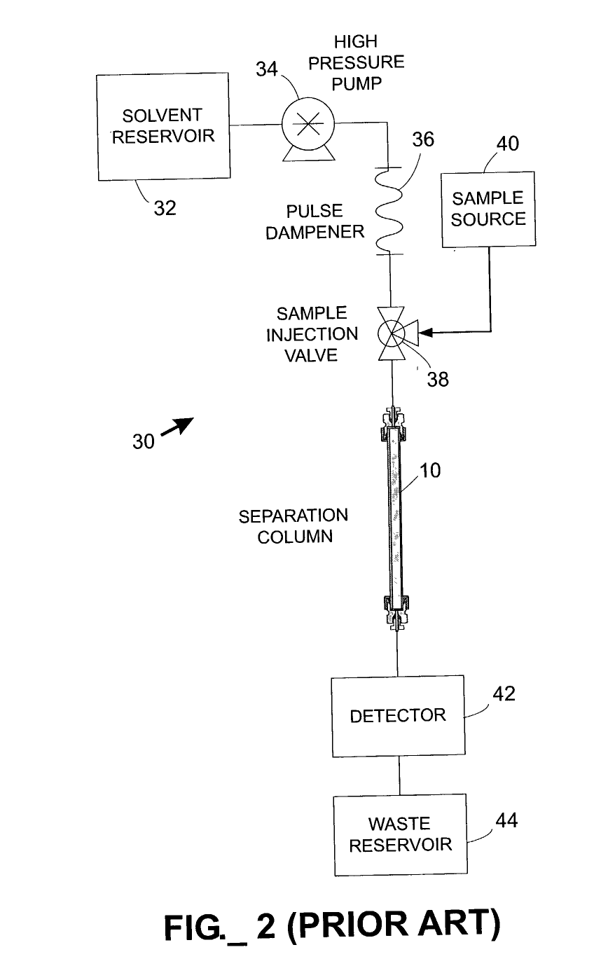

### DETAILED DESCRIPTION OF PREFERRED EMBODIMENTS OF THE INVENTION

Definitions

The terms “channel” or “chamber” as used herein is to be interpreted in a broad sense. Thus, such terms are is not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete amount of fluid for a specified amount of time. “Channels” and “chambers” may be filled or may contain internal structures comprising, for example, valves, filters, stationary phase media, and similar or equivalent components and materials.

The term “microfluidic” as used herein refers to structures or devices through which one or more fluids are capable of being passed or directed, and which have at least one dimension less than about 500 microns.

The term “separation channel” is used substantially interchangeably with the term “column” herein and refers to a region of a fluidic device containing stationary phase material adapted to separate species of a fluid sample

The term “substantially sealed” as used herein refers to a microstructure having a sufficiently low unintended leakage rate and/or volume under given flow, fluid identity, and pressure conditions. A substantially sealed device may include one or more inlet ports and/or outlet ports.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates or other stencils.

The term “column” as used herein refers to a region of a fluidic device containing stationary phase material, typically including packed particulate matter.

The term “slurry” as used herein refers to a mixture of particulate matter and a solvent, preferably a suspension of particles in a solvent.

Microfluidic Devices Generally

Devices according to the present invention are preferably microfluidic devices defining internal channels or other microstructures having at least one dimension smaller than about 500 microns. In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within the stencil layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely-dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permit robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. In certain embodiments, particularly preferable materials include those that are substantially optically transmissive to permit viewing and/or electromagnetic analyses of fluid contents within a microfluidic device. Various preferred embodiments may utilize porous materials, including filter materials, for device layers. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties.

Various means may be used to seal or bond layers of a device together, preferably to construct a substantially sealed structure. For example, adhesives may be used. In one embodiment, one or more layers of a device may be fabricated from single- or double-sided adhesive tape, although other methods of adhering stencil layers may be used. A portion of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thicknesses of these carrier materials and adhesives may be varied.

In another embodiment, device layers may be directly bonded without using adhesives to provide high bond strength (which is especially desirable for high-pressure applications) and eliminate potential compatibility problems between such adhesives and solvents and/or samples. Specific examples of methods for directly bonding layers of polyolefin (e.g., non-biaxially-oriented polypropylene) materials to form stencil-based microfluidic structures are disclosed in two co-pending U.S. provisional patent applications, No. 60/338,286 (filed Dec. 6, 2001) and No. 60/393,953 (filed Jul. 2, 2002), both of which are hereby incorporated by reference as if set forth fully herein. In one embodiment, multiple layers of 7.5-mil (188 micron) thickness “Clear Tear Seal” polypropylene (American Profol, Cedar Rapids, Iowa) including at least one stencil layer may be stacked together, placed between flat glass platens and compressed to apply a pressure of 0.26 psi (1.79 kPa) to the layered stack, and then heated in an industrial oven for a period of approximately 5 hours at a temperature of 154° C. to yield a permanently bonded microstructure well-suited for use with high-pressure column packing methods. One thin layer of thermally conductive material (e.g., carbon steel) may be optionally inserted along the inside face of each glass platen to contact the outermost device layers using the same process to promote more even heating.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Pressure-Driven Microfluidic Separation Utilizing On-Column Injection

Performing liquid chromatography in microfluidic volumes provides significant cost savings by reducing column packing materials, analytical and biological reagents, solvents, and waste. Microfluidic separation devices may also be made to be disposable, thus eliminating possible contamination of samples due to re-use of separation columns and eliminating the need to flush columns between separations. Embodiments fabricated with sandwiched stencil layers provide additional advantages, such as rapid and inexpensive prototyping and production, and the ability to use a wide range of materials portions of a device. Additionally, microfluidic devices are well-suited for performing multiple operations in parallel, thus permitting substantial increases in throughput (namely, the number of separations that can be performed within a particular period) to be obtained.

As described in co-pending U.S. patent application Ser. No. 10/161,415 (filed Jun. 3, 2002, commonly assigned to the same assignee as the present application, and incorporated by reference as if set forth fully herein), preferred microfluidic separation devices utilize provide on-column, rather than pre-column, injection of samples onto one or more microfluidic separation columns. In other words, rather than being injected upstream of a separation channel, a sample is injected onto a microfluidic separation channel between an upstream end and a downstream end. On-column injection prevents a sample from ever encountering potential irregularities and manufacturing imperfections that might be found at the upstream end of a separation channel containing a stationary phase material. It is beneficial to avoid sample flow through a poorly packed region to promote high-quality separation, since the quality of separation in chromatography depends heavily on the size of the injection plug, with a small and well-defined plug generally providing better results. Stationary phase regions that are not uniformly packed tend to cause undesirable “smearing” of sample plugs. Thus, as compared to devices employing pre-column sample injection, microfluidic separation columns utilizing on-column injection permit the time-consuming and wasteful step of trimming (or otherwise eliminating) a poorly packed upstream end of a separation channel to be avoided.

One method for fabricating microfluidic separation devices developed by the assignee of the present application includes the steps of flowing slurry at high pressure through a slurry inlet port into a microfluidic separation channel, and then retaining particulate material from the slurry using a porous region disposed at the downstream end of the separation channel. A sample injection region disposed between the upstream end and the downstream end of the separation channel includes an associated porous region to prevent the introduction of particulate material. When such a device is in use, both mobile phase solvent and sample may be supplied through the sample injection region to the separation channel. After the separation channel is packed with particulate material, the slurry inlet port is sealed, such as by using a mechanical plug, using epoxy, or heat-sealing. The effect of sealing the slurry inlet port is to provide a very high upstream impedance to fluid flow. Thus, despite the high impedance provided by the stationary phase material downstream of the sample injection region, when a sample is supplied to the separation channel, it will tend to flow in the desired direction toward the downstream end since the downstream direction provides less impedance to fluid flow than the upstream direction.

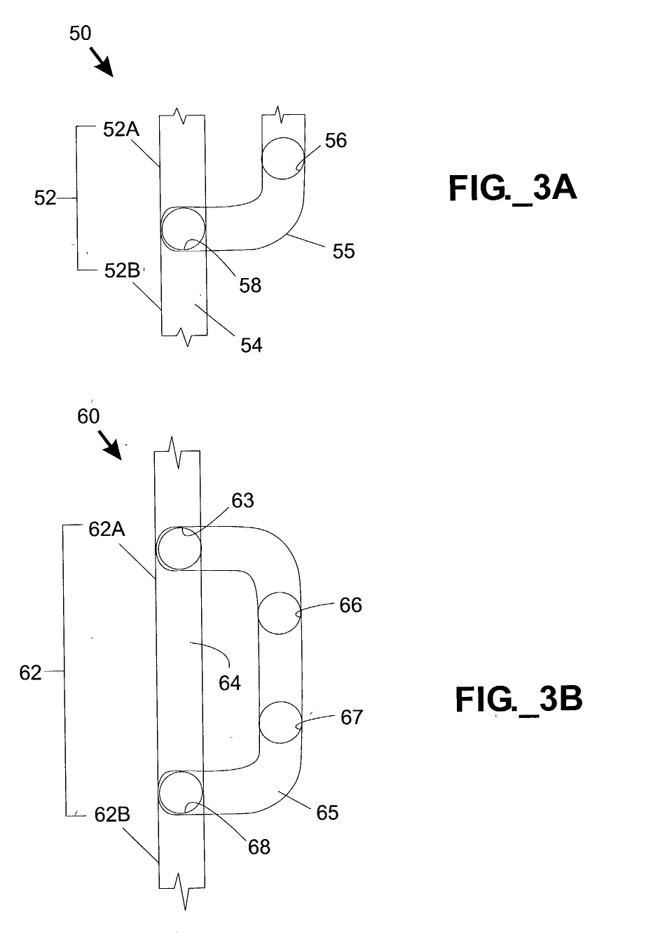

A potential drawback of employing on-column injection in a device as just described, however, is that during operation the addition of pressurized fluid to the stationary phase material tends to cause any particles unrestrained by a porous material or frit to move, thus permitting the stationary phase material within the separation channel to become “unpacked.” For example, referring to FIG. 3A, a microfluidic device 50 includes a separation channel 52 and a sample loading segment 55 having a sample inlet port 56. The sample loading segment 55 is in fluid communication with the separation channel 52 at a junction 58 that preferably includes a porous membrane (not shown). The junction 58 is disposed between an upstream portion 52A and a downstream portion 52B of the separation channel 52, with both the upstream portion 52A and the downstream portion 52B containing a packed stationary phase material 54. If it is assumed that the upstream portion 52A includes a sealed upstream end (not shown) and that both mobile phase and sample are supplied to the separation channel 52 by way of the sample loading segment 55, then such conditions may give rise to problems with maintaining the stationary phase material 54 uniformly packed near the junction 58.

As noted previously, after the separation channel 52 is packed with a slurry, it is extremely difficult to achieve uniform and complete packing near the slurry inlet or upstream end (not shown) of the separation channel 52. Due to the method of chip fabrication, the upstream end of the separation channel 52A lacks a porous material intended to retain packed stationary phase material. Upon sealing the slurry inlet to impede fluid flow in the upstream direction in the upstream portion 52A of the separation channel 52, it is believed that a small pocket of air typically becomes trapped within the upstream portion 52A. When pressurized fluid is supplied to the separation channel 52 by way of the sample loading channel 55 and junction 58, this pressure may be sufficient to push the stationary phase material 54 disposed in the upstream portion 52A in an upstream direction, away from the junction 58 and toward the upstream end. Because the air pocket disposed at the upstream end is compressible, this permits some upstream migration of the stationary phase material 54 contained in the upstream portion 52A, thus reducing the local packing density of the stationary phase material 54. The problem is exacerbated upon release of the fluid pressure within the sample loading channel 55 and separation channel 52, since the air pocket compressed near the upstream end tends to expand to an equilibrium state, thus pushing the stationary phase material 54 contained in the upstream portion 52A in a downstream direction, toward the junction 58. What results is slight but observable back-and-forth movement of this stationary phase material 54 for each pressure cycle experienced by the separation channel 52 that serves to reduce the packing density of (or “unpack”) the stationary phase material 54 contained in the upstream portion 52A. As discussed previously, this condition tends to interfere with obtaining high-quality separations, since stationary phase regions that are not uniformly packed tend to cause undesirable “smearing” or broadening of sample plugs. Such a condition may make it difficult to ensure that the entire volume of a discrete sample plug will flow from a sample loading segment 55 and into the downstream portion 52B of the separation channel without migrating into a region of lower packing density along the junction 58.

Improved Microfluidic Separation Devices And Methods

To avoid undesirable packing density variations in a microfluidic separation device employing on-column sample injection by way of a sample loading segment, embodiments of the present invention permit pressurized mobile phase (solvent) to be communicated simultaneously to both the upstream portion of a separation channel and to a sample loading segment. For example, referring to FIG. 3A, the upstream end of a microfluidic separation channel 52 may be left unsealed, and when operating the device 50, mobile phase may be supplied simultaneously to both the upstream portion 52A (e.g., through upstream end of the separation channel 52) and the sample loading channel 55 upstream of the sample inlet port 56. Preferably, a first mobile phase inlet (not shown) in fluid communication with the upstream portion 52A, and a second mobile phase inlet (not shown) disposed upstream of the sample inlet port 56, are provided. The terms “first” and “second” in this context refer to the inlets, not to any particular solvent. The first mobile phase inlet and the second mobile phase inlet preferably receive the same solvent or solvent mixture (i.e., mobile phase). In one embodiment, the first mobile phase inlet and the second mobile phase inlet each comprise an inlet port. Distinct mobile phase inlet ports may be used, or the first and second mobile phase inlet ports may comprise a single common inlet port. A first mobile phase inlet and a second mobile phase inlet may or may not be in fluid communication with one another within the microfluidic device. Preferably, the sample inlet port 56 is selectively sealed, such as by using a removable mechanical seal (not shown), to allow a sample to be loaded into the sample inlet port 56 when the mechanical seal is removed, and to permit pressure-driven separation to commence when the mechanical seal is applied (i.e., by retaining mobile phase pressure within the sample loading segment 55 and separation channel 52).

In another embodiment, a sample loading segment may comprise a bypass segment in fluid communication with a separation channel at more than one location. For example, referring to FIG. 3B, a microfluidic device 60 includes a microfluidic separation channel 62 having an upstream portion 62A and a downstream portion 62B, both portions 62A, 62B containing packed stationary phase material 64. The terms “upstream” and “downstream” as applied to portions 62A, 62B of the separation channel 62 indicate positions relative to the sample loading junction 68, with the boundary between the upstream portion 62A and the downstream portion 62B being defined at this junction 68. A sample loading segment 65 is in fluid communication with the separation channel 62 at both a solvent splitting junction 63 and the sample loading junction 68, such that the sample loading segment 65 comprises a bypass segment. The solvent splitting junction 63 serves as a mobile phase inlet to the sample loading channel 65, with a portion of the mobile phase proceeding through the separation channel 62 and a portion of the mobile phase being diverted into the sample loading segment 65. A porous region (not shown) preferably disposed at each junction 63, 68 to prevent the passage of stationary phase material 64 into the sample loading segment 65. The sample loading segment 65 is in further communication with two sample ports 66, 67. The use of multiple sample ports 66, 67 helps facilitate the injection of a small but repeatable volume of sample, since upon injection through the upstream port 66, the sample will flow into the sample loading segment 65 toward the downstream port 67 to define a sample plug in the portion of the loading segment 65 between the two ports 66, 67, with the excess flowing out of the downstream port 67. A mechanical seal (not shown) is preferably associated with the two sample ports 66, 67. After loading the sample plug, the mechanical seal is closed to disallow further flow through the ports 66, 67, and then mobile phase flow may be re-established to push the sample plug through the sample loading segment 65, through the sample loading junction 68, and into the separation channel 62 to be eluted in the downstream portion 62B.

In both of the foregoing microfluidic separation devices 50, 60, it is believed that providing pressurized mobile phase simultaneously to both the (upstream portion of the) separation channel and associated sample loading segment prevents stationary phase material from unpacking within the separation channel, and ensures that sample plugs flow exclusively from the sample loading channel toward the downstream portion of the separation channel.

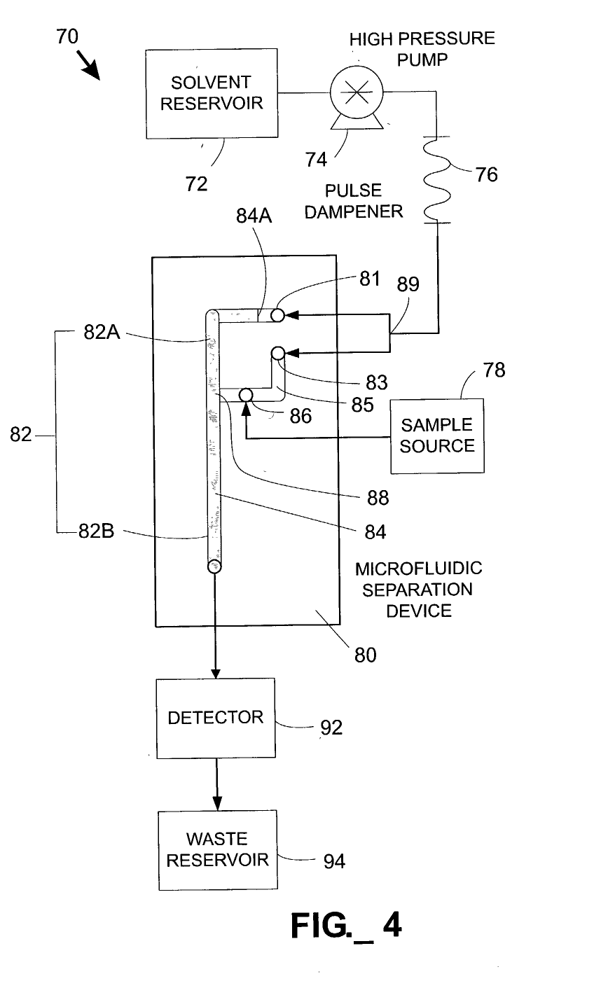

In another embodiment, a microfluidic separation device permitting simultaneous communication of pressurized mobile phase to both the upstream portion of a separation channel and to a sample loading segment may be included in a separation system. For example, FIG. 4 provides a schematic illustrating various components of a separation system 70 adapted to separate species of a sample using a technique such as liquid chromatography with a pressure-driven microfluidic separation device 80 permitting on-column sample injection. A solvent reservoir 72 contains mobile phase solvent. While a single reservoir 72 is shown, multiple reservoirs 72 may be provided to perform gradient separation. A solvent pump 74 pressurizes mobile phase solvent supplied from the reservoir 72. If additional solvent reservoirs 72 are provided, then preferably one or more additional pump 74 are also provided. IN an alternative embodiment, the pump(s) 74 may be replaced by a pressure source such as pressurized gas supplied directly to the solvent reservoir(s) 72 to motivate a flow of mobile phase solvent through the microfluidic separation device 80. One or more pulse dampers 76 are preferably provided to reduce pressure pulses generated by the solvent pump(s) 72. The microfluidic separation device 80 includes a separation channel 82 having an upstream portion 82A and a downstream portion 82B, with both portions 82A, 82B containing stationary phase material 84. Preferably, the stationary phase material includes packed particulate matter, such as may be supplied to the device in slurry form through a mobile phase inlet 81. The upstream portion 82A includes a trailing edge 84A of stationary phase material 84 adjacent to the mobile phase inlet 81. A sample loading segment 85 includes a sample inlet port 86 (in fluid communication with an external sample source 78) and another mobile phase inlet 83 disposed upstream of the sample inlet port 86. The sample loading segment 85 is in fluid communication with the separation channel 82 at a sample loading junction 88 that preferably includes a porous material (not shown) adapted to permit the passage of fluid but retain stationary phase material 84 within the separation channel 82. Another porous material (not shown) is preferably provided at the downstream end of the downstream portion 82B of the separation channel and adapted to permit the passage of fluid but retain stationary phase material within the separation channel 82. A common solvent may be supplied to both the first mobile phase inlet 81 and the second mobile phase inlet 83 such as by using a splitter 89 located either on-board or external to the microfluidic device 80. Downstream of the separation channel 82, a detector 92 may be provided to detect one or more properties of the separated species, and a waste reservoir 94 may be provided to collect mobile phase and solvent exiting the microfluidic device 80. Preferably, the sample inlet port 86 is selectively sealed, such as by using a removable mechanical seal (not shown), to allow a sample to be loaded into the sample inlet port 86 when the mechanical seal is removed, and to permit pressure-driven separation to commence when the mechanical seal is applied.

To permit operate of the separation system 70, solvent (mobile phase) is preferably supplied first to the microfluidic device 82 to thoroughly wet the stationary phase material 84 contained in the separation channel 82. During the wetting step, the sample inlet port 86 should be mechanically sealed to prevent solvent from escaping the device 80 through the sample inlet port 86. After the separation channel 82 has been thoroughly wetted, the solvent pump 74 is preferably deactivated and the separation channel 82 is preferably depressurized to permit sample injection. With the mechanical seal removed from the sample inlet port 86, a fluidic sample from the sample source 78 (e.g., a pipettor) may be injected through the sample inlet port 86 and into the sample loading segment 85. After the mechanical seal is reapplied to the sample inlet port 86, the solvent pump 74 is preferably activated to reinitiate mobile phase flow into the first and the second mobile phase inlets 81, 83. Notably, mobile phase provided to the second mobile phase inlet 83 serves to push the fluid sample from the sample loading segment 85 through the sample loading junction 88 and into the separation channel 82, where the sample is eluted by the stationary phase material 84 contained in the downstream portion 82B.

Following elution, one or more properties of the separated species may be detected by the detector 92. The detector 92 may be adapted to detect fluid properties of the separated species either within or outside the microfluidic device 80, and materials with suitable optical and mechanical properties are preferably selected for portions of the microfluidic device 80 (e.g., windows) to facilitate such detection. While various detection technologies may be used, preferred technologies include optical spectroscopies including absorbance, fluorescence, Raman scattering, polarimetry, circular dichroism and refractive index detection. Window materials can also be used to permit other analytical techniques such as scintillation, chemilluminescence, electroluminescence, and electron capture. A range of electromagnetic energies can be used including ultraviolet, visible, near infrared, and infrared. Additionally, techniques such as electrochemical detection, capacitive measurement, conductivity measurement, mass spectrometry, nuclear magnetic resonance, evaporative light scattering, ion mobility spectrometry, and matrix-assisted laser desorption ionization may be performed in conjunction with the separation system 70.

Downstream of the detector 92 is a waste reservoir 94. In an alternative embodiment, a sample collector (not shown) may be substituted for the waste reservoir 94. Although not shown, the system 70 preferably further includes a controller (e.g., a microprocessor-based controller) for controlling the various components of the system 70.

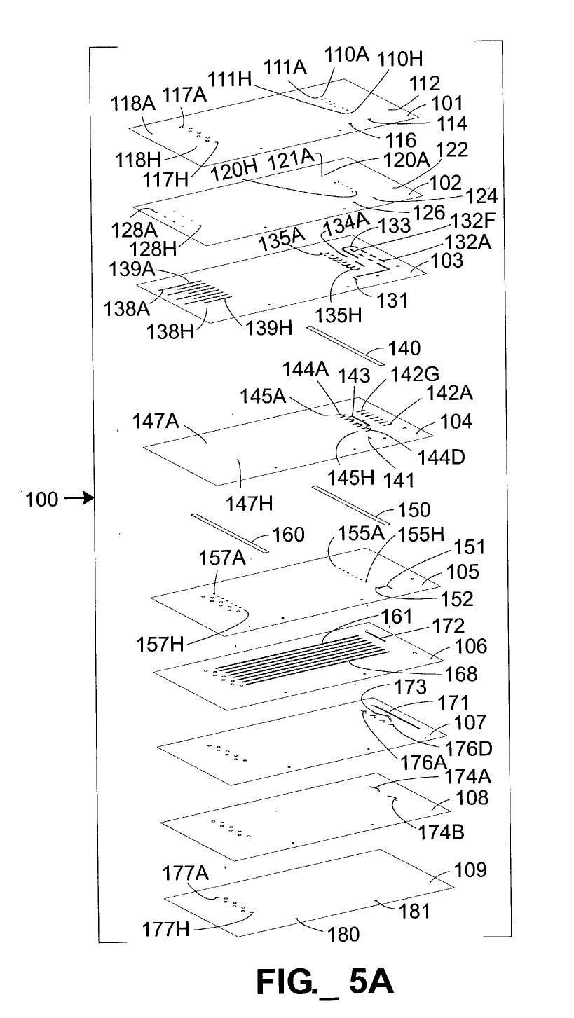

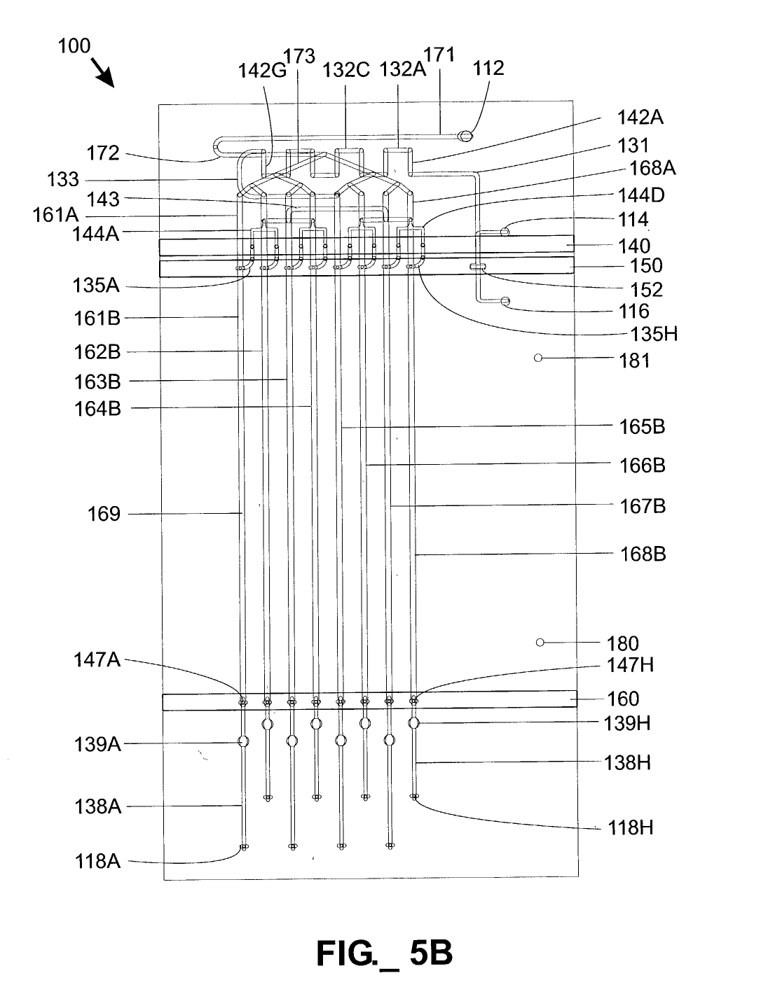

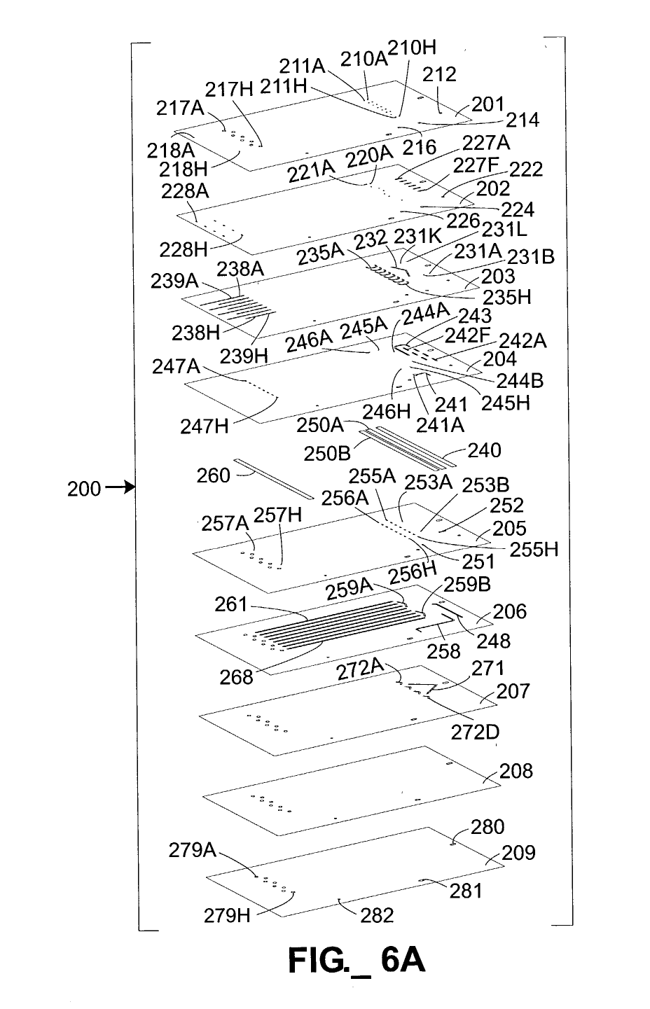

In a preferred embodiment, a pressure-driven microfluidic separation device includes multiple separation channels and multiple discrete sample inputs to permit multiple different samples to be separated simultaneously using a minimum number of expensive system components such as pumps, pulse dampers, etc. For example, FIGS. 5A-5B illustrate a pressure-driven microfluidic separation device 100 including eight separation channels 161-168. The device 100 may be constructed with nine device layers 101-109, including multiple stencil layers 103-108. Each of the nine layers 101-109 defines two alignment holes 180, 181, which may be used in conjunction with fixed external pins (not shown) to aid in aligning the layers 101-109 during construction and/or to aid in aligning the device 100 with an external interface such as a mechanical seal (not shown) or slurry packing apparatus (not shown).

The first layer 101 defines several fluidic ports: three solvent inlet ports 112, 114, 116 that are used to admit mobile phase solvent to the device 100; eight pairs of sample ports 110A-110H and 111A-111H that permit samples to be supplied to sample loading segments 135A-135H (defined in the third layer 103); and eight outlet ports 118A-118H to permit mobile phase and separated sample species to exit the device 100 downstream of the separation channels 161-168. Due to the sheer number of elements depicted in FIGS. 5A-5B, numbers for selected elements within alphanumeric series groups (e.g., sample ports 110B-110G, 111B-111G, sample loading segments 135B-135G, outlet ports 118B-118G) are omitted for clarity. Notably, of the three solvent inlet ports 112, 114, 116, the first solvent inlet port 112 is additionally used to admit slurry to the device 100 during a column packing procedure. The first layer 101 further defines eight apertures 117A-117H that, along with identical apertures 177A-177H defined in the fifth through ninth device layers 105-109, facilitate optical detection by locally reducing the thickness of material bounding (from above and below) the detection regions 139A-139H of channels 138A-138H defined in the third layer 103.

The second through sixth layers 102-106 each define a first solvent via 122 for communicating a mobile phase solvent from a first mobile phase inlet port 112 to a transverse channel 171 defined in the seventh layer 107. A second solvent via 124 is defined in each of the second through fourth device layers 102-104 for communicating a mobile phase solvent from the second mobile phase inlet port 114 to a channel segment 151 defined in the fifth layer 105. A third solvent via 126 is defined in the second layer 102 to communicate a mobile phase solvent from the third mobile phase inlet port 116 to an initial solvent mixing channel 131 defined in the third layer 103. Eight pairs of sample vias 120A-120H and 121A-121H defined in the second layer 102 are interposed between the sample ports 110A-110H and 111A-111H and the sample loading segments 135A-135H defined in the third layer. Additionally, eight outlet vias 128A-128H are interposed between the outlet ports 118A-118H and the channels 138A-138H defined in the third layer 103.

In addition to the structures described previously, the third layer 103 defines a series of six transverse segments 132A-132F and a curved channel 133. The transverse segments 132A-132F and curved channel 133, when coupled with the longitudinal segments 142A-142G defined in the fourth layer 104, form continuous flow path between the initial solvent mixing channel 131 and the large forked channel 143 defined in the fourth layer 104. Further defined in the third layer 103 are two transverse segments 134A, 134B that fluidically couple the large forked channel 143 to four small forked channels 144A-144D defined in the fourth layer 104. In addition to the structures described previously, the fourth layer 104 defines eight sample loading vias 145A-145H and eight effluent vias 147A-147H. A first porous membrane 140 is disposed between the third and fourth layers 103, 104, between the sample loading channels 135A-135H (defined in the third layer 103) and the small forked channels 144A-144D in the fourth layer 104. The purpose of this first porous membrane 140 is to impede the flow of samples (which are injected into the device 100 through sample input ports 110A-110H) into the small forked channels 144A-144H, thus preventing undesirable cross-talk or contamination between samples.

The fifth layer 105 defines a channel segment 151, eight junction vias 155A-155H disposed below the vias 145A-145H defined in the fourth layer 104, and eight effluent vias 157A-157H disposed at the downstream end of each separation channel 161-168. Two porous materials 150, 160 are disposed between the fourth layer 104 and the fifth layer 105. These materials 150, 160 serve as frits to retain stationary phase material 169 within the separation channels 161-168 defined in the sixth layer 106. In other words, the frits 150, 160 permit the passage of liquid solvent, but impede the passage of stationary phase material 169. If the stationary phase material 169 includes packed particulate matter, then the frits 150, 160 preferably have a pore size that is smaller than each particle to be retained. Although various materials may be used for the frits 150, 160 (and the porous membrane 140), a preferred material for constructing these elements 140, 150, 160 is a permeable polypropylene membrane such as, for example, 1-mil (25 microns) thickness Celgard 2500 membrane (55% porosity, 0.209×0.054 micron pore size, Celgard Inc., Charlotte, N.C.). This is particularly preferred when the device layers 101-109 are fabricated with a substantially adhesiveless polyolefin material, such as non-biaxially-oriented polypropylene, using direct (e.g. thermal) bonding methods such as discussed herein. Devices 100 constructed according to such methods may be readily capable of withstanding (internal) operating pressures of 10 psi (69 kPa), 50 psi (345 kPa), 100 psi (690 kPa), 500 psi (3450 kPa), or even greater pressures.

The sixth layer 106 defines eight parallel separation channels 161-168 and a transverse channel segment 172. The seventh layer 107 defines an elongate transverse channel 171, one large forked channel 171, and four small forked channels 176A-176D. The eighth layer 108 defines two intermediate forked channels 174A-174B that permit fluid communication between the large forked channel 171 and the four small forked channels 176A-176D. The eighth layer 109, which serves to bound the forked channels 174A-174B from below, defines no channels; rather it defines only alignment holes 180-181 and apertures 177A-177H that facilitate optical detection.

Stationary phase material 169 is preferably added to the device 100 after the various layers 101-109 and porous elements 140, 150, 160 are laminated or otherwise bonded together to form an integral structure. While various types of stationary phase material may be used, preferred types include packed particulate material, and preferred packing methods employ slurry. One preferred slurry includes silica powder having surface chemical groups (e.g., Pinnacle II™ C-18 silica, 5-micron, catalog no. 551071, Restek Corp., Bellefonte, Pa.) and acetonitrile (MeCN), such as in a ratio of 1.00 grams particulate to 500 ml of solvent. Pressurized slurry may be supplied to the device 100 by way of a solvent inlet port 112. From the solvent inlet port 112 and associated vias 122, the slurry is split to the eight separation channels 161-168 through a microfluidic channel network that includes an elongate transverse channel segment 171, a reversing transverse channel segment 172, the large forked channel 173, the intermediate forked channels 174A-174B, and the small forked channels 176A-176D. Upon filling the separation channels 161-168, particulate matter within the slurry is prevented from leaving by way of the frits 150, 160, and solvent separated from the slurry emerges from the device 100 through the downstream frit 160, vias 147A-147H, channels 138A-138H, vias 128A-128H, and finally the outlet ports 118A-118H. Preferably, pressurized slurry is added to the device 100 until not only the separation channels 161-168 are filled, but also the forked channels 176A-176D, 174A-174D, 173 and the transverse segments 171-172 are filled so as to leave a trailing edge of stationary phase material disposed adjacent to the solvent inlet port 112.

In operation of the device 100, a first mobile phase solvent may be supplied to one solvent inlet port 114 and a second mobile phase solvent may be supplied to another solvent inlet port 116. These two solvents meet within the mixing channel 131 adjacent to the slit 141 (defined in the fourth layer 104), after which the two solvents are laminated one atop the other to promote mixing. Preferably, each solvent is supplied by an independently controlled pressure source (e.g., a pump) to permit gradient separation to be performed within the device 100. From the mixing channel 131, the combined solvents flow through a compact composite channel composed of seven longitudinal segments 142A-142G alternated with six transverse segments 132A-132F that provide a relatively long channel structure within a compact area. From the last longitudinal channel 142G, the solvent mixture flows into a curved channel 133 leading to a composite splitter including a large forked channel 143, a two intermediate channel segments 134A-134B, and four small forked channels 144A-144D that in turn supply the solvent mixture to the sample loading channels 135A-135H upstream of the sample loading ports 110A-110H. The sample loading channels 135A-135H are in fluid communication with the separation channels 161-168 at sample loading junctions 155A-155H disposed between the upstream portions 161A-168A and downstream portions 161B-168B of the separation channels 161-168. The junctions 155A-155H demarcate the transition from the upstream portions 161A-168A and the downstream portions 161B-168B.

Another pressurized solvent stream is supplied to the device 100 through the solvent inlet port 112 leading to the provided the solvent mixture flows into a curved channel 143 leading to a composite splitter including the large forked channel 173, two medium forked channels 174A-174B, and four small forked channels 176A-176D that divide the solvent mixture among the eight separation channels 161-168. This second solvent stream provided through the solvent inlet port 112 helps prevent stationary, phase material from unpacking within the separation channel, and also helps to ensures that sample plugs injected into the sample loading channels 135A-135H flow exclusively through the downstream portions 161B-168B of the separation channels 161-168. Preferably, the solvent supplied to this solvent inlet port 112 comprises one of the multiple solvents that may be supplied through the sample loading channels 135A-135H. For example, if gradient separation is desired using water and acetonitrile as solvents and C-18 silica stationary phase material 169, then the solvent to be supplied to the solvent inlet port 112 preferably comprises water or acetronitrile (MeCN). More preferably, the solvent to be supplied to the solvent inlet port 112 is the solvent that will encounter the greater fluidic impedance by traveling through the fluidic network including channels 171, 172, 143, 144A-144B, 145A-145D that contain stationary phase material 159. Thus, in the same example as just mentioned above, where water and acetonitrile are solvents supplied through the sample loading channels 135A-135H, the solvent supplied to the device 100 through the solvent inlet port 112 would preferably be water since it is more difficult to flow water through packed C-18 silica particulate matter.

After the stationary phase material 169 is fully wetted with solvent, samples may be added to the device 100 through the sample ports 110A-110H and 111A-111H. Preferably, solvent flow is interrupted and the device is temporarily depressurized (e.g., by disengaging a removable mechanical seal (not shown) from the sample loading ports 110A-110H, 111A-111H) to permit the samples to be loaded. Two sample ports (e.g., 110A, 111A) correspond to each sample loading segment (e.g., 135A) of the eight sample loading segments 135A-135H defined in the third layer 103. Preferably, different samples are provided to each upstream port (110A-110H) and each sample flows within a portion of a sample loading segment 135A-135H to emerge through the downstream port 111A-111H so as to define a sample plug of a repeatable volume in each sample loading segment between the upstream port (e.g., port 110A) and downstream port (e.g., 111A). After the samples are loaded, the sample loading ports 110A-110H, 111A-111H are preferably re-sealed (e.g., by disengaging a removable mechanical seal (not shown)) and solvent flow through solvent ports 112, 114, 116 is re-initiated. The solvents supplied into the sample loading segments 135A-135H from the sample inlet ports 114, 116 sweep the sample plugs onto the separation columns 161-168 where they flow into the through downstream portions 161B-168B and are eluted.

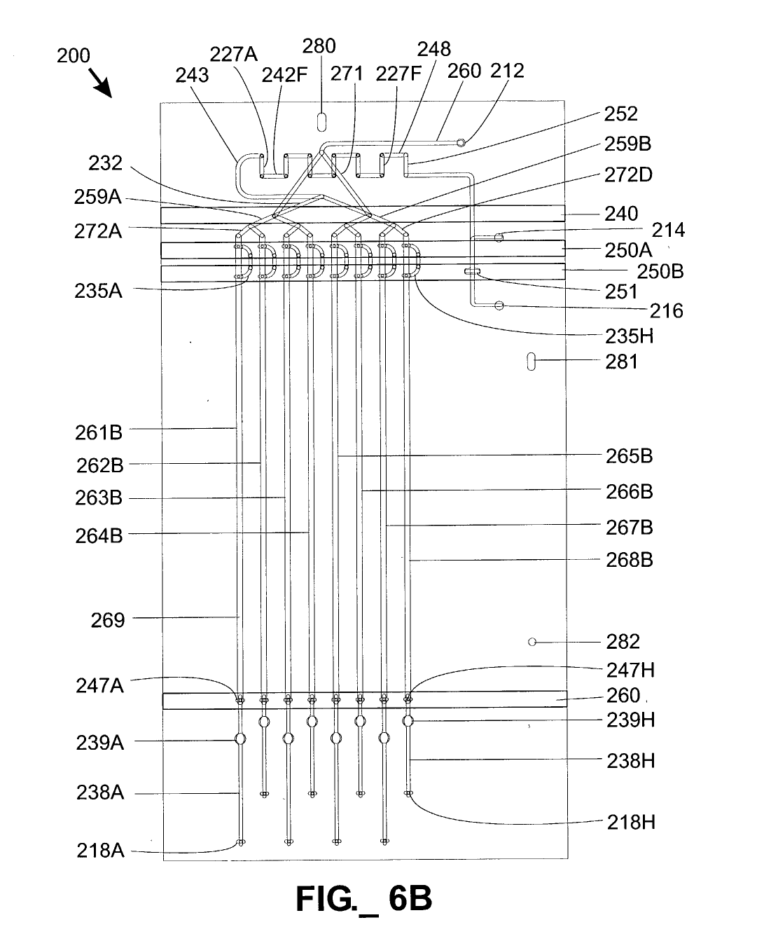

Another embodiment, similar in many respects to the device 100 just described, is shown in FIGS. 6A-6B. This pressure-driven microfluidic separation device 200 including eight separation channels 261-268. The device 200 may be constructed with nine device layers 201-209, including multiple stencil layers 202-207. Each of the nine layers 201-209 defines three alignment holes 280-282, which may be used in conjunction with fixed external pins (not shown) to aid in aligning the layers 201-209 during construction and/or to aid in aligning the device 200 with an external interface such as a mechanical seal (not shown) or slurry packing apparatus (not shown).

The first layer 201 defines several fluidic ports: one slurry inlet port 212 (that is used during a column packing procedure to supply stationary phase material 269 to the separation channels 261-268); two solvent inlet ports 214, 216 that are used to admit mobile phase solvents (e.g. for gradient separation) to the device 200; eight pairs of sample ports 210A-210H and 211A-211H that permit samples to be supplied to sample loading segments 235A-235H (defined in the third layer 203); and eight outlet ports 218A-218H that permit mobile phase and separated sample species to exit the device 200 downstream of the separation channels 261-268. As before, numbers for selected elements within alphanumeric series groups are omitted for clarity. The first layer 201 further defines eight apertures 217A-217H that, along with identical apertures 279A-279H defined in the fifth through ninth device layers 205-209, facilitate optical detection by locally reducing the thickness of material bounding (from above and below) the detection regions 239A-239H of outlet channels 238A-238H defined in the third layer 203.

The second through fifth layers 202-205 each define a slurry via 222 for communicating a stationary phase material (e.g., combined with a liquid in slurry form) from the slurry inlet port 212 to a transverse channel 248 defined in the sixth layer 207. A first solvent via 224 is defined in each of the second and third device layers 202-203 for communicating a first mobile phase solvent from the first mobile phase inlet port 214 to a channel segment 241 defined in the fourth layer 204. A second solvent via 226 is defined in the second through fifth device layers 202-205 to communicate another mobile phase solvent from the second mobile phase inlet port 216 to an initial solvent mixing channel 258 defined in the sixth layer 206. Eight pairs of sample vias 220A-220H and 221A-221H defined in the second layer 202 are interposed between the sample ports 210A-210H and 211A-211H and the sample loading segments 235A-235H defined in the third layer 203. Additionally, eight outlet vias 228A-228H are interposed between the outlet ports 218A-218H and the channels 238A-238H defined in the third layer 203. The second layer further defines six longitudinal segments 227A-227F that, coupled with the transverse segments 242A-242F (defined in the fourth layer 204) and small vias 231A-231K (defined in the third layer 203) provide additional contraction/expansion regions (marked by vias 231A-231K) downstream of the primary mixing channel 258. That is, after two mobile phase solvents are laminated one atop another in the mixing channel 258, further and more complete mixing between the two solvents is promoted by passage through the series of small vias 231A-231K (which cause the solvent flow to contract) and transverse segments 242A-242F and longitudinal segments 227A-227F (which permit the solvent flow to expand upon exiting each small via 231A-231K).

The third layer 203 defines (in addition to the structures described previously) a large forked channel 232, eight bypass sample loading channels 235A-235B, and eight outlet channels 238A-238H each having an enlarged region 239A-239H to facilitate optical detection of species following separation of samples in the separation channels 261-268. The fourth layer defines six transverse segments 242A-242F, a curved channel 243, two solvent vias 244A-244B (in fluid communication with the large forked channel 232), eight sample loading inlet vias 245A-245H, and eight sample loading outlet vias 246A-246H. Each sample loading inlet via 245A-245H is in fluid communication with a separation channel 261-268 by way of a first porous frit 250A and a solvent splitting junction 255A-255H (defined in the fifth layer 205), while each sample loading outlet via 246A-246H is in fluid communication with a separation channel 261-268 by way of a second porous frit 250B and a sample loading junction 256A-256H (also defined in the fifth layer 205).

The fifth layer 205 defines (in addition to the structures described previously) a slit 251 that permits fluid communication between channel segment 241 (defined in the fourth layer 204) and the mixing channel 258, and facilitates lamination of one solvent atop the other to promote mixing within the mixing channel 258. The fifth layer 205 further defines a longitudinal channel segment 252 that permits fluid communication between the mixing channel 258 and the first transverse segment 242A defined in the fourth layer 204. Fluid communication between the downstream end of the separation channels 261-268 and the outlet channels 238A-238H is established by way of vias 247A-247H (defined in the fourth layer 204), a frit 260, and vias 257A-257H (defined in the fifth layer 205).

In addition to defining the separation channels 261-268, the sixth layer 206 defines two intermediate forked channels 259A-259B, a mixing channel 258, and a transverse segment 248. The seventh layer 207 defines a large forked channel 271 (for splitting a flow of slurry during a column packing procedure) and four small forked channels 272A-272D. The eighth layer 208 (which serves to bound the forked channels 274A-274B from below) and ninth layer 209 are identical, and could be combined into a single layer if desired. Neither of these layers 208, 209 define any channels; rather, they define only alignment holes 280-281 and apertures 279A-279H that facilitate optical detection.

As was the case with the device 100 according to the previous embodiment, the device 200 is preferably fabricated with a substantially adhesiveless polyolefin material, such as non-biaxially-oriented polypropylene, using direct (e.g. thermal) bonding methods such as discussed herein. Such a device 200 is preferably adapted to withstand (internal) operating pressures of 10 psi (69 kPa), 50 psi (345 kPa), 100 psi (690 kPa), 500 psi (3450 kPa), or even greater pressures. With regard to the porous materials 240, 250A, 250B, 260, various porous materials may be used but a preferred material for constructing these elements 240, 250A, 250B, 260 includes a permeable polypropylene membrane such as, for example, 1-mil (25 microns) thickness Celgard 2500 membrane (55% porosity, 0.209×0.054 micron pore size, Celgard Inc., Charlotte, N.C.)—particularly if the device layers 202-209 are fabricated with nonbiaxially-oriented polypropylene.

If the stationary phase material 269 includes packed particulate matter, then the frits 240, 250A, 250B, 260 preferably have a pore size that is smaller than each particle to be retained. Although various materials may be used for the frits 240, 250A, 250B, 260, a preferred material for constructing these elements 240, 250A, 250B, 260 is a permeable polypropylene membrane such as, for example, 1-mil (25 microns) thickness Celgard 2500 membrane (55% porosity, 0.209×0.054 micron pore size, Celgard Inc., Charlotte, N.C.).

Stationary phase material 269 is preferably added to the device 200 after the various layers 201-209 and porous elements 240, 250A, 250B, 260 are laminated or otherwise bonded together to form an integral structure. While various types of stationary phase material may be used, preferred types include packed particulate material, and preferred packing methods employ slurry. One preferred slurry includes silica powder having surface chemical groups (e.g., Pinnacle II™ C-18 silica, 5-micron, catalog no. 551071, Restek Corp., Bellefonte, Pa.) and acetonitrile (MeCN), such as in a ratio of 1.00 grams particulate to 500 ml of solvent. Pressurized slurry may be supplied to the device 200 by way of the slurry inlet port 212. From the slurry inlet port 212 and associated vias 222, the slurry is split to the eight separation channels 261-268 through a microfluidic channel network that includes an elongate transverse channel segment 248, the large forked channel 271, the intermediate forked channels 259A-259B, and the small forked channels 272A-272D. Upon filling the separation channels 261-268, particulate matter within the slurry is retained by the frits 240, 250A, 250B, 260, and solvent separated from the slurry emerges from the device 200 through the downstream frit 260, vias 247A-247H, channels 238A-238H, vias 228A-228H, and finally the outlet ports 218A-218H. Preferably, pressurized slurry is added to the device 200 until not only the separation channels 261-268 are filled, but also the forked channels 272A-272D, 259A-259B, 271 and the transverse segment 248 are substantially filled so as to leave a trailing edge of stationary phase material disposed adjacent to the solvent inlet port 212. After the packing procedure is complete, the slurry inlet port 212 is preferably sealed, either temporarily (e.g., with a screw or other removable means) or permanently (e.g., with epoxy or localized heating). This is in marked contrast to the device 100 according to previous embodiment, since that device 100 was intended to receive a flow of pressurized solvent into the solvent inlet port 112

While the device 100 (described previously in connection with FIGS. 5A-5B) included multiple sets of both intermediate and small forked channels (each set in fluid communication with only one large forked channel 143, 173), the device 200 according to the present embodiment provides two large forked channels 232, 271 that are both in fluid communication with the same set of intermediate forked channels 259A-259B and small forked channels 272A-272D. To prevent the passage of slurry into one large forked channel 232, a frit 240 is fluidically disposed between the large forked channel 232 and the medium forked channels 259A-259B.

Another notable difference between the device 200 and the device 100 described in connection with FIGS. 5A-5B is that the device 200 according to the current embodiment includes bypass sample loading channels 235A-235H rather than non-bypass sample loading segments 135A-135H. Each bypass sample loading channel 235A-235H is in fluid communication with a separation channel 261-268 through both a solvent splitting junction 255A-255H and a sample loading junction 256A-256H. When solvents supplied to the upstream portion 261A-261H of each separation channel 261-268 encounter the solvent splitting junction 255A-255H, a portion of the solvents will flow into the bypass sample loading segments 235A-235H while the remainder of the solvents will continue traveling down the separation channels 261-268 toward the sample loading junction 256A-256H. That is, for each solvent stream supplied to the upstream end of a separation channel 261-268, a first portion of the stream continues to flow within the channel 261-268, while the remaining portion of the stream is split into a bypass sample loading segment 235A-235H that reconnects with the first portion at a sample loading junction 256A-256H. This design causes solvent flow to push the stationary phase material 269 within each separation channel 261-268 toward the outlet vias 257-257H, thus ensuring that the stationary phase material 269 remains packed not only in the downstream portions 261B-268B but also the upstream portions 261A-268A of each separation channel 261-268. Each sample loading junction 256A-256H demarcates the transition from an upstream portions 261A-268A to a downstream portion 261B-268B of the eight separation channels 261-268. Preferably, the portion of each separation channel 261-268 disposed between a solvent splitting junction 255A-255H and a sample loading junction 256A-256H provides a greater resistance to fluid flow than corresponding bypass path (i.e., through a via 255A-255H, a frit 250A, another via 245A-245H, a bypass sample loading segment 235A-235H, another via 246A-246H, another frit 250B, and finally another via 256A-256H).

In operation of the device 200, a first mobile phase solvent may be supplied to one solvent inlet port 214 and a second mobile phase solvent may be supplied to another solvent inlet port 216. These two solvents meet within the mixing channel 258 adjacent to the slit 251 (defined in the fifth layer 205), after which the two solvents are laminated one atop the other to promote mixing. Preferably, each solvent is supplied by an independently controlled pressure source (e.g., a pump) to permit gradient separation to be performed within the device 200. From the mixing channel 258, the combined solvents flow through a longitudinal segment 252 into further mixing regions formed by seven longitudinal segments 242A-242G, the small vias 231A-231K, and six transverse segments 227A-227F. From the last longitudinal channel 242G, the solvent mixture flows into a curved channel 243 leading to a composite splitter including a large forked channel 232, a two intermediate channel segments 2594A-259B, and four small forked channels 272A-272D that in turn supply the solvent mixture to the upstream end of each of the eight separation channels 261-268.

After the stationary phase material 269 is fully wetted with solvent, samples may be added to the device 200 using the sample ports 210A-210H, 211A-211H. Preferably, solvent flow is interrupted and the device is temporarily depressurized to permit the samples to be loaded. Two sample ports (e.g., 210A, 211A) correspond to each sample loading segment (e.g., 235A) of the eight sample loading segments 235A-235H defined in the third layer 203. Preferably, different samples are provided to each upstream port (210A-210H) and each sample flows within a portion of a sample loading segment 235A-235H to emerge through the downstream port 211A-211H so as to define a sample plug of a repeatable volume in each sample loading segment between the upstream port (e.g., port 210A) and downstream port (e.g., 211A). After the samples are loaded, solvent flow is re-initiated, and solvent flow through each bypass sample loading segment 235A-235H serves to carry each sample through a sample loading junction 256A-256H into the separation channels 261-268 where they are eluted to separate individual species.

While FIGS. 5A-5B and FIGS. 6A-6B each depict microfluidic devices 100, 200 having eight microfluidic separation channels 161-168, 261-268 and appurtenant microstructures, it will be readily apparent to one skilled in the art that any number of separation channels may be provided in a microfluidic separation device. Higher density microfluidic separation devices, each having many more than eight separation channels, are specifically contemplated.

It is also to be appreciated that the foregoing description of the invention has been presented for purposes of illustration and explanation and is not intended to limit the invention to the precise manner of practice herein. It is to be appreciated therefore, that changes may be made by those skilled in the art without departing from the spirit of the invention and that the scope of the invention should be interpreted with respect to the following claims.

What is claimed is:

1. A pressure-driven microfluidic separation device comprising:
a microfluidic separation channel having an upstream portion and a downstream portion, the upstream portion and the downstream portion both containing a stationary phase material;
a sample loading segment having a sample inlet port adapted to receive a liquid sample, the sample loading segment being in fluid communication with the microfluidic separation channel at a sample loading junction, wherein the upstream portion is disposed upstream of the sample loading junction, and the downstream portion is disposed downstream of the sample loading junction;
a first mobile phase solvent inlet in fluid communication with the upstream portion; and
a second mobile phase solvent inlet in fluid communication with the sample loading segment upstream of the sample inlet port.

2. The device of claim 1 wherein the stationary phase material includes packed particulate matter.

3. The device of claim 2 wherein the downstream portion of the separation channel has a downstream end, the device further comprising a porous region disposed at the downstream end and adapted to retain the packed particulate matter within the separation channel.

4. The device of claim 3 wherein the porous region includes a porous membrane.

5. The device of claim 2, further comprising a porous region disposed at the sample loading junction and adapted to retain the packed particulate matter within the separation channel.

6. The device of claim 5 wherein the porous region includes a porous membrane disposed between the separation channel and the sample loading segment.

7. The device of claim 1, further comprising a mixing region adapted to promote mixing between at least two mobile phase solvents, the mixing region being in fluid communication with at least one of the upstream portion and the sample loading segment upstream of the sample inlet port.

8. The device of claim 1 wherein the first mobile phase solvent inlet and the second mobile phase solvent inlet are in fluid communication with a common mobile phase solvent inlet port, the device further comprising a splitting region in fluid communication with the common mobile phase solvent inlet port and adapted to divide a mobile phase solvent flow between the first mobile phase solvent inlet and the second mobile phase solvent inlet.

9. The device of claim 1 wherein the sample inlet port is adapted to receive a liquid sample from a pipettor.

10. The device of claim 1 wherein the device is fabricated with a plurality of stencil layers, each stencil layer of the plurality of stencil layers having a thickness and defining at least one channel through the entire thickness of the stencil layer.

11. The device of claim 1 wherein the device is fabricated with a plurality of adhesiveless polymer layers.

12. The device of claim 1 wherein the device is fabricated with a polyolefin material.

13. The device of claim 1 wherein the device is fabricated with a substantially optically transmissive material.

14. The device of claim 1 wherein the separation channel is adapted to operate with a fluid pressure of greater than or equal to about 10 psi.

15. The device of claim 1 wherein the separation channel is adapted to operate with a fluid pressure of greater than or equal to about 50 psi.

16. The device of claim 1 wherein the separation channel is adapted to operate with a fluid pressure of greater than or equal to about 100 psi.

17. A pressure-driven microfluidic separation device comprising:
a plurality of microfluidic separation channels, each separation channel of the plurality of channels having an associated sample loading junction, wherein each sample loading junction demarcates a transition between an upstream portion of the associated separation channel containing a stationary phase material and a downstream portion of the associated separation channel containing a stationary phase material;
a plurality of sample loading segments, each sample loading segment of the plurality of sample loading segments being in fluid communication with a separation channel of the plurality of separation channels at the associated sample loading junction and having a sample inlet port adapted to receive a liquid sample;
a first mobile phase solvent inlet port;
a first channel network adapted to conduct a solvent from the first mobile phase solvent inlet port to each upstream portion;
a second mobile phase solvent inlet port; and
a second channel network adapted to conduct a solvent from the second mobile phase solvent inlet port to each sample loading segment of the plurality of sample loading segments.

18. The device of claim 17 wherein the stationary phase material includes packed particulate matter.

19. The device of claim 18 wherein each separation channel of the plurality of separation channels has a downstream end, the device further comprising a porous region disposed at each downstream end and adapted to prevent the passage of packed particulate matter.

20. The device of claim 19 wherein the porous region comprises at least one porous membrane.

21. The device of claim 17, further comprising a porous region disposed at each sample inlet junction.

22. The device of claim 17, further comprising:
a third mobile phase solvent inlet port; and
a microfluidic mixer adapted to promote mixing between at least two mobile phase solvent supplied to the first mobile phase solvent inlet port and the third mobile phase solvent inlet port, the mixing region being in fluid communication with the first channel network.

23. The device of claim 22 wherein the mixer includes a plurality of mixing regions.

24. The device of claim 22 wherein the mixer includes an overlap mixing region.

25. The device of claim 22 wherein the mixer includes a plurality of contraction/expansion regions.

26. The device of claim 17 wherein the first mobile phase solvent inlet port and the second mobile phase solvent inlet port comprise a common mobile phase solvent inlet port, the device further comprising a splitting region in fluid communication with the common mobile phase solvent inlet port and adapted to divide a mobile phase solvent flow between the first channel network and the second channel network.

27. The device of claim 17 wherein each sample inlet port is adapted to receive a liquid sample from a pipettor.

28. The device of claim 17 wherein the device is fabricated with a plurality of stencil layers, each stencil layer of the plurality of stencil layers having a thickness and defining at least one channel through the entire thickness of the stencil layer.

29. The device of claim 17 wherein the device is fabricated with a plurality of adhesiveless polymer layers.

30. The device of claim 17 wherein the device is fabricated with a polyolefin material.

31. The device of claim 17 wherein the device is fabricated with a substantially optically transmissive material.

32. The device of claim 17 wherein the plurality of microfluidic separation channels are adapted to operate with a fluid pressure of greater than or equal to about 10 psi.

33. The device of claim 17 wherein the plurality of microfluidic separation channels are adapted to operate with a fluid pressure of greater than or equal to about 50 psi.

34. The device of claim 17 wherein the plurality of microfluidic separation channels are adapted to operate with a fluid pressure of greater than or equal to about 100 psi.

35. A fluidic separation system comprising:
the pressure-driven microfluidic separation device of claim 17;
a pressure source adapted to supply a pressurized solvent to the separation device;
a sample reservoir adapted to deliver at least one liquid sample containing multiple species to the separation device; and
a detector adapted to detect a property of at least one species of the liquid sample following pressure-driven separation within the separation device.

36. A method for operating a pressure-driven microfluidic separation device, the method comprising the steps of:
providing a microfluidic separation channel containing a stationary phase material, the separation channel having an upstream end, a downstream end, and a sample loading region disposed between the upstream end and the downstream end;
providing a sample loading segment in fluid communication with the separation channel at the sample loading region;
introducing a sample into the sample loading segment; and
supplying a first flow of mobile phase solvent to the separation channel upstream of the sample loading region.

37. The method of claim 36, further comprising the step of supplying a second flow of mobile phase solvent to the sample loading segment.

38. The method of claim 36 wherein the steps of supplying the first flow of mobile phase solvent and supplying the second flow of mobile phase solvent are performed substantially simultaneously.

39. The method of claim 36 wherein the first flow of mobile phase solvent comprises a first solvent component and a second solvent component, the method further comprising the steps of:
mixing the first solvent component and the second solvent component; and
varying the proportion of the first solvent component to the second solvent component.

40. The method of claim 39 wherein the mixing step is performed within the microfluidic device.

41. The method of claim 36, further comprising the step of dividing a unitary stream of mobile phase solvent into the first flow of mobile phase solvent and the second flow of mobile phase solvent.

42. The method of claim 41 wherein the dividing step is performed within the microfluidic separation device.

43. The method of claim 36 wherein the sample loading segment is a bypass segment, the sample loading segment being in fluid communication with the separation channel at both the sample loading region and a junction disposed upstream of the sample loading region.

44. The method of claim 36, further comprising the step of wetting the stationary phase material with solvent prior to the introducing step.
